(19) United States
(12) Patent Application Publication
(10) Pub. No.: US 2022/0334648 A1
(43) Pub. Date: Oct. 20, 2022

(54) WEARABLE INFORMATION TERMINAL, CONTROL METHOD THEREOF, AND STORAGE MEDIUM

(71) Applicant: CANON KABUSHIKI KAISHA, Tokyo (JP)

(72) Inventor: Hiroyuki Okamoto, Kanagawa (JP)

(21) Appl. No.: 17/719,247

(22) Filed: Apr. 12, 2022

(30) Foreign Application Priority Data
Apr. 15, 2021 (JP) 2021-068875

(51) Int. Cl. G06F 3/01; G06F 3/04847; G06V 20/20; G06F 3/04845; G02B 27/01

(52) U.S. Cl. CPC G06F 3/017; G06F 3/04847; G06V 20/20; G06F 3/011; G06F 3/04845; G02B 27/0172; G02B 2027/0178; G02B 2027/014

(57) ABSTRACT

The wearable information processing apparatus according to the present disclosure includes projecting means for projecting an operation screen on a field of vision of a user through the information processing apparatus, wherein the projected operation screen has first and second modes, and wherein an operation screen displayed in the second mode has a smaller size than an operation screen displayed in the first mode, or the operation screen displayed in the second mode is displayed nearer to the field of vision of the user than the operation screen displayed in the first mode.

### BACKGROUND OF THE INVENTION

### Field of the Invention

The present invention relates to a wearable information terminal such as smart glasses, a control method thereof, and a storage medium for switching an operation method according to situations.

### Description of the Related Art

In recent years, various technologies have been proposed for smart glasses (head-mounted display), which are devices such as glasses or helmets wearable on the head area.

AR (Augmented Reality)/MR (Mixed Reality) glasses, a type of smart glasses, recognize the real space with cameras and sensors, and display AR images to match the real space. Then, the AR image can be viewed as if it is real, and the displayed AR image can also be used as a virtual UI (user interface). Users can interact with the device by touching the virtual UI of the AR video, moving their arms or fingers, and other gestures. Japanese Patent Application Laid-Open No. 2018-527465 discloses that numerical values can be set by gestures to a virtual UI. There are two modes for setting numerical values: coarse adjustment mode and fine adjustment mode. Then, a user can flexibly perform numerical setting without inconvenience by switching the modes by gestures according to the numerical value to be set. By using the technology described in Japanese Patent Application Laid-Open No. 2018-527465, a user can suitably perform the numerical value setting by gesture operation to a virtual UI.

When the user performs a gesture operation on the virtual UI, there are cases where the gesture operation cannot be performed sufficiently depending on the surrounding environments. For example, it is one of cases that performing the gesture operation is inappropriate in view of manners or in certain places, such as a crowded place.

### SUMMARY OF THE INVENTION

In view of the foregoing, the present disclosure provides a method for allowing to suitably operate a terminal even when gesture operation cannot be sufficiently performed.

The wearable information processing apparatus according to the present disclosure comprises: at least one memory; and at least one processor in communication with the at least one memory, wherein the at least one processor of the information processing apparatus is configured to perform: projecting an operation screen on a field of vision of a user through the information processing apparatus, wherein the projected operation screen has first and second modes, an operation screen displayed in the second mode having a smaller size than an operation screen displayed in the first mode, or wherein the operation screen displayed in the second mode is displayed nearer to the field of vision of the user than the operation screen displayed in the first mode.

Further features of the present invention will become apparent from the following description of exemplary embodiments with reference to the attached drawings.

### BRIEF DESCRIPTION OF THE DRAWINGS

FIG. 1 shows a system configuration diagram including smart glasses in the embodiment of the present disclosure.

FIG. 2 shows a hardware configuration of the smart glasses in the embodiment of the present disclosure.

FIG. 3 shows a software configuration of the smart glasses in the embodiment of the present disclosure.

FIG. 4 shows an example of a virtual UI used by a user in the normal mode according to the embodiment of the present disclosure.

FIG. 5 shows an example of a virtual UI used by a user in the silent mode according to the embodiment of the present disclosure.

FIG. 6 shows a flow chart showing detailed flow at the mode switching according to the embodiment of the present disclosure.

FIG. 7 shows an example of UI for selecting a type of the silent mode according to the embodiment of the present disclosure.

FIG. 8 shows a flow chart showing detailed flow at the mode switching according to another embodiment of the present disclosure.

FIG. 9A shows an example of UI for notifying the operation method after the mode switching according to another embodiment of the present disclosure.

FIG. 9B shows an example of UI for notifying the operation method after the mode switching according to another embodiment of the present disclosure.

FIG. 9C shows an example of UI for notifying the operation method after the mode switching according to another embodiment of the present disclosure.

FIG. 9D shows an example of UI for notifying the operation method after the mode switching according to another embodiment of the present disclosure.

FIG. 10 shows a flow chart showing detailed flow at the mode switching according to another embodiment of the present disclosure.

FIG. 11 shows an example of a mode switching threshold set spatially according to another embodiment of the present disclosure.

### DESCRIPTION OF THE EMBODIMENTS

The best embodiments of the present disclosure will now be described in detail with reference to the accompanying drawings.

### First Embodiment

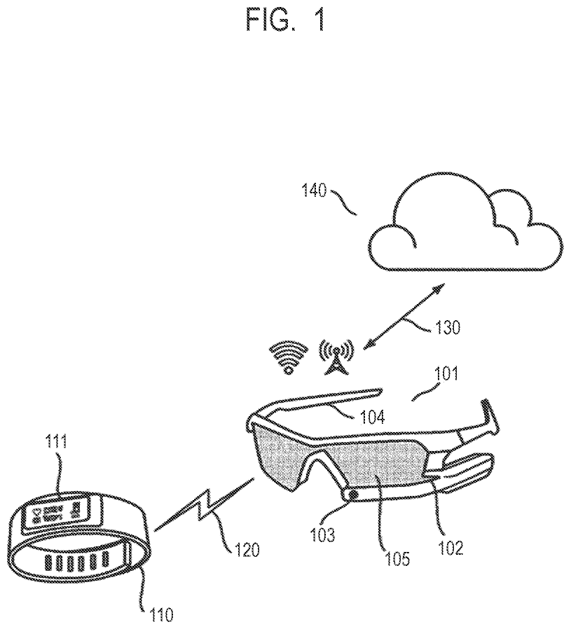

FIG. 1 shows an example of the system configuration diagram including a wearable information terminal (smart glasses) and a device associated therewith. The wearable information terminal is a device capable of communicating with a mobile network (mobile communication network) 130 and the Internet 140 directly or via a mobile router (not shown), and the present invention refers to smart glasses 101 as an example thereof. A smart glass for a single eye and a head-mounted display can be used as a wearable information terminal. The wearable device is an information device having a notification function such as a display and a vibration function and a communication function such as Bluetooth (registered trademark) capable of communicating with a wearable information device, and the present disclosure mentions a smartwatch 110 as an example.

The smart glasses 101 are a wearable information terminal mounted near the user's eye, and display a virtual image in the field of view on a display 102 without obstructing the field of view of the user. Such a display method is called AR (Augmented Reality) or MR (Mixed Reality) and is provided by a function of projecting information onto a transmissive display (lens 105), a user's retina (not shown), or the like. Although FIG. 1 provides an image to a single eye, the smart glasses 101 for projecting an image to the field of view of both eyes may be applied in the present invention.

The display 102 is provided with a camera unit 103 for capturing an object in the direction of the user's line of sight. An operation frame 104 is provided with a touch sensor as well as a frame, and is an operation unit for operating a terminal. A speaker function is built in the operation frame 104, and the sound can be transmitted to the user.

The smart glasses 101 may implement an embedded module such as an eSIM (embedded subscriber identity module), which allows to be connected to the Internet 140 via a mobile network 130 using the 4G or 5G line. The smart glasses 101 may be connected to the mobile network 130 via a mobile router owned by the user and Wi-Fi (registered trademark) or USB (registered trademark) or the like. The smart glasses 101 can be connected to the Internet 140 via Wi-Fi or the like without going through the mobile network 130.

The smartwatch 110 is a wristwatch type information terminal worn by a user on the wrist, and a display 111 not only displays information such as time but also functions as a touch panel to operate the terminal. Wireless communications 120 are used for exchanging data between the smart glasses 101 and the smartwatch 110. The wireless communications 120 may be Bluetooth (registered trademark) standard, but is not limited thereto. The smartwatch 110 has a vibration function as well as a display function.

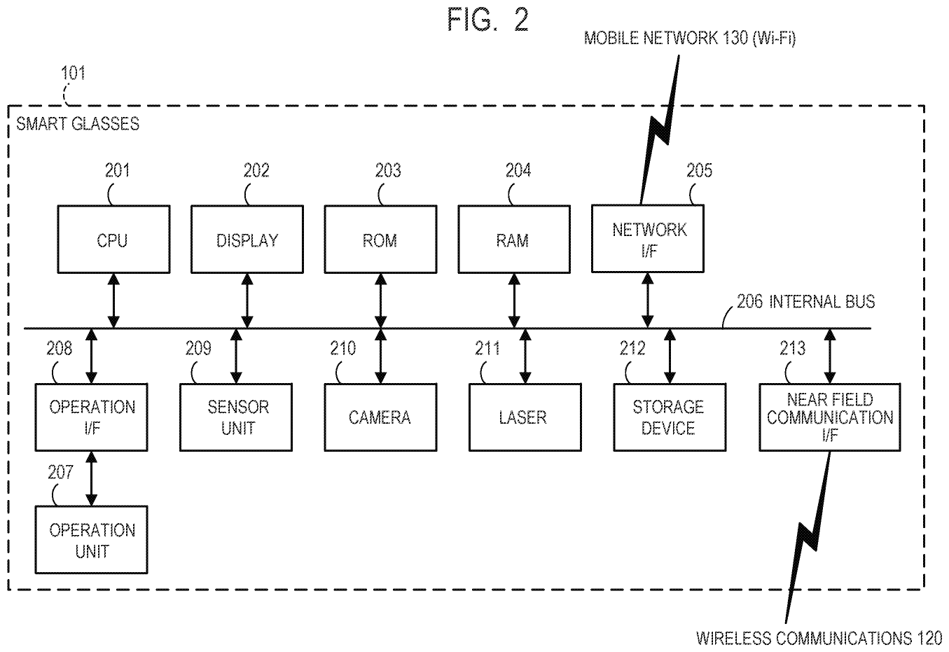

FIG. 2 shows the hardware configuration of the smart glasses 101.

A CPU 201 integrally controls various functions of the smart glasses 101 via an internal bus 206 by a program stored in a ROM 203. An outcome of a program executed by the CPU 201 can be projected and displayed as an image on the user's field of view by a display 202. In the present embodiment, the display system is assumed to be a system in which a user views what is projected by the display 202 into the field of view through a transmissive lens 105. However, it is also possible to employ a method in which the display 202 projects directly onto the retina. The ROM 203 is a flash memory or the like, and stores various setting information and an application program or the like described above. ARAM 204 functions as a memory and a work area of the CPU 201. A network interface (I/F) 205 is a hardware module for the connection to the mobile network 130 and Wi-Fi. If the mobile router is used, a USB I/F (not shown) of the smart glasses 101 can be used for connection.

An operation unit 207 receives an input from the user through the operation frame 104, and transmits a signal corresponding to the input to each of the aforementioned units by an operation I/F 208. A sensor unit 209 is one or more sensors, but simply illustrated as a single unit. Specifically, at least one of a GPS, a gyro sensor, an acceleration sensor, a proximity sensor, a blood pressure/heart rate measuring sensor and the like is mounted on the smart glasses 101. A sensor for detecting biometric information for realizing the authentication through a fingerprint, vein, iris or the like may be mounted on the smart glasses 101. A camera 210 has an image capturing function, and captured image data are stored in the ROM 203. A laser 211 projects various contents onto the display 202. In case of the retinal projection system, the laser 211 projects the content directly onto the retina. A storage device 212 is a storage medium and is a device for storing various data such as applications. The smart glasses 101 may also include devices for reading and deleting data from the storage medium. Some terminals include no storage device 212 but include only the ROM 203. A near field communication I/F 213 is an interface used for communications with the smartwatch 110 or the like, and realizes, for example, the wireless communications 120.

Although not shown, the smart glasses 101 may further include a configuration for voice communications using a network or a telephone line for working as a substitution of modern smartphones. Specifically, the smart glasses 101 are equipped with components for connection to the telephone line, a speaker, a microphone, and a voice control chip.

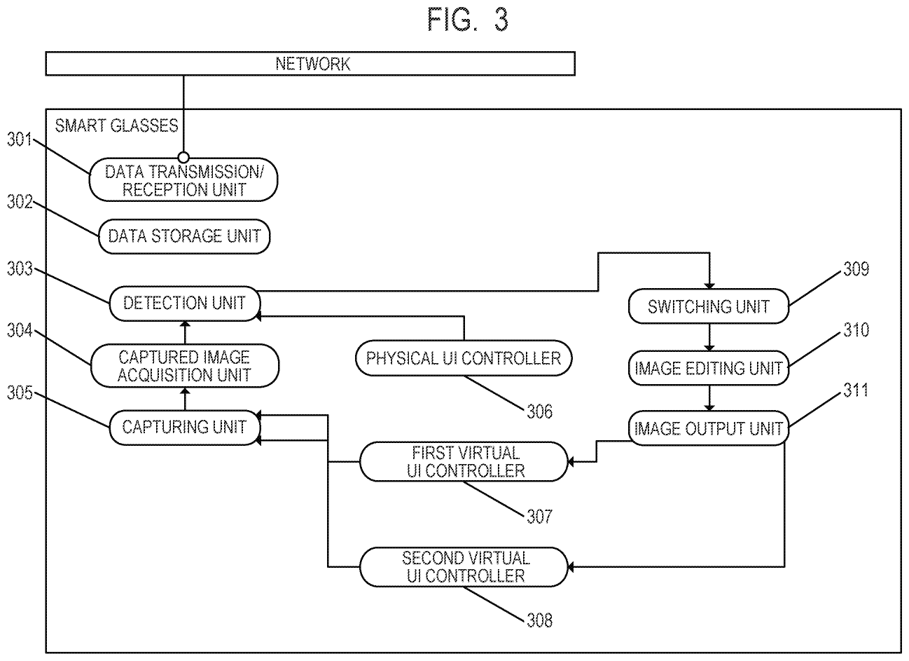

The software configuration of the smart glasses according to the present embodiment will be described with reference to FIG. 3.

Each unit 301 to 311 shown in FIG. 3 as components of the software is stored as a program in the ROM 203 described in FIG. 2, and is expanded to the RAM 204 at the time of execution and executed by the CPU 201.

A data transmission/reception unit 301 transmits/receives data to/from an external device through a network. A data storage unit 302 stores application programs such as a Web browser, an OS, related programs, data stored by a user, and the like.

A physical UI controller 306 controls inputs of a physical UI to be operated by directly touching the operation frame 104 of the smart glasses 101, and transmits information to a detection unit 303. A first virtual UI controller 307 and a second virtual UI controller 308 control display of an operation screen of an AR video which may become a virtual UI. The virtual UI based on the AR video displayed by the first virtual UI controller 307 is a UI used by a user in a normal operation mode (hereinafter referred to as “normal mode”). The virtual UI based on the AR video displayed by the second virtual UI controller 308 is a UI used by the user in an operation mode under a situation where it is not appropriate to operate the smart glasses with a large gesture (this mode is hereinafter referred to as “silent mode”).

A capturing unit 305 converts an image of the outside view and a gesture image by a user inputted through the camera unit 103 into an electric signal, and a captured image acquisition unit 304 acquires the electric signal.

The detection unit 303 detects an input to the virtual UI by the gesture of the user from the image acquired by the captured image acquisition unit 304, and detects, from the information received from the physical UI controller 306, necessary information such as switching information used for switching a mode to the silent mode.

If the detection unit 303 detects the input of switching the normal mode and the silent mode, the switching unit 309 switches the normal mode and the silent mode of the device and transmits the switched contents to an image editing unit 310.

The image editing unit 310 determines and edits the image of the operation screen to be output according to the operation mode of the present device. An image output unit 311 transfers the edited video of the operation screen edited by the image editing unit 310 to the first virtual UI controller 307 or the second virtual UI controller 308, and the first virtual UI controller 307 or the second virtual UI controller 308 displays the edited video of the operation screen on the virtual UI.

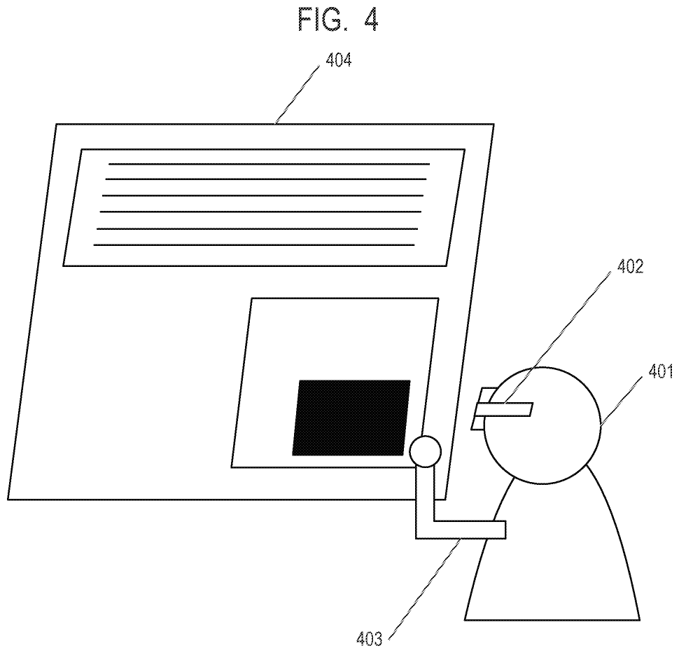

FIG. 4 shows an example of a virtual UI used by a user in the normal mode according to the present embodiment.

FIG. 4 shows a user 401, smart glasses 402, an arm 403 of a user who performs a gesture, and a virtual UI 404 based on an AR image controlled by the first virtual UI controller 307.

The user 401 is a user who operates the smart glasses 402, and wears the smart glasses 402 on the head area, and operates the first virtual UI 404 with a gesture by the arm 403. The virtual UI 404 is a UI screen viewed by the user via the smart glasses 402. The position of the touch operation to the UI screen from the user is detected to let the smart glasses perform necessary processing corresponding to the operation. In the normal mode, the virtual UI is displayed in a large size in order to prevent erroneous operation.

For example, a UI screen is displayed with of a size as large as the user can reach the screen by spreading arms. In the normal mode, the user can operate the first virtual UI 404 with a large gesture.

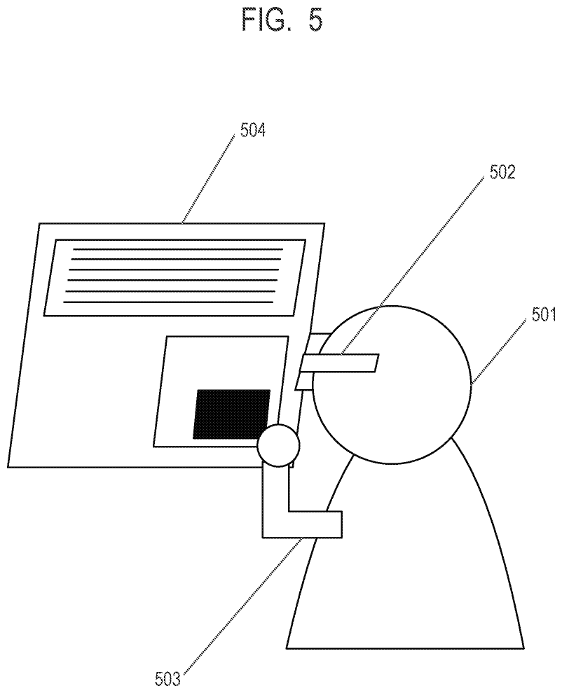

FIG. 5 shows an example of the virtual UI used by the user in the silent mode according to the present embodiment.

FIG. 5 shows a user 501, smart glasses 502, an arm 503 of a user who performs a gesture, and a virtual UI 504 using an AR image controlled by the second virtual UI controller 308.

The user 501 is a user who operates the smart glasses 502, and wears the smart glasses 502 on the head area, and operates the second virtual UI 504 with a gesture by the arm 503.

Since the second virtual UI 504 used by the user in the silent mode is smaller in size than the first virtual UI 404 or the second virtual UI 504 is displayed closer to the user, the user can operate the smart glasses 502 using the virtual UI as an operation screen even in a narrow space. When it is not appropriate for the user to operate the virtual UI with a large gesture, the user can operate the second virtual UI with a small gesture by switching a mode to the silent mode. At this time, the detection unit 303 may set a range for detecting operations from the user to be smaller.

In the present embodiment, only one type of the second virtual UI 504 is used to describe the virtual UI to be used in the silent mode, but multiple types of virtual UI as an operation screen to be used in the silent mode may be used.

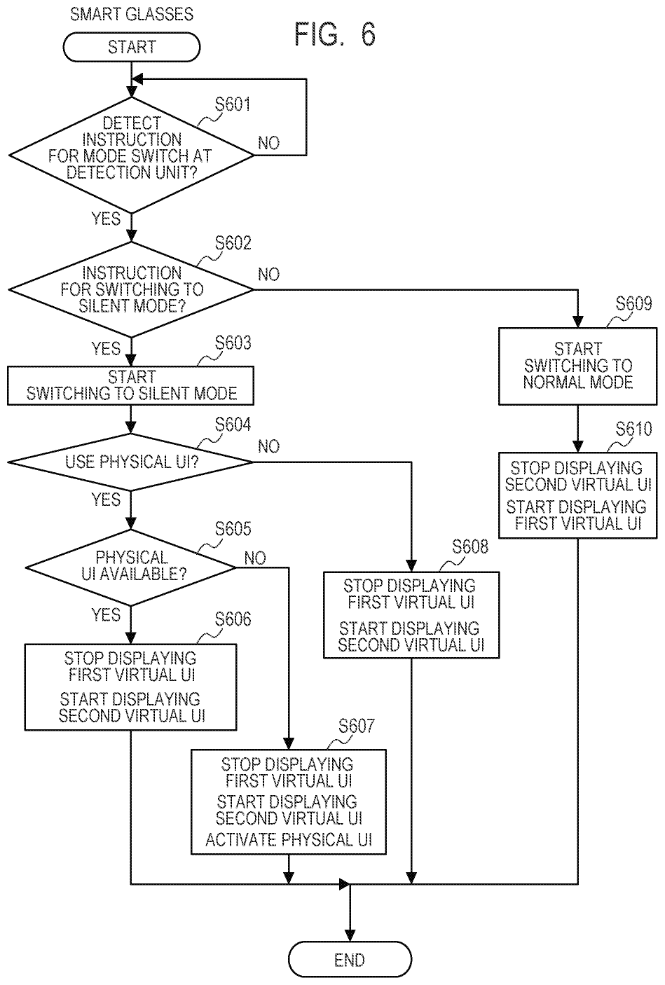

The detailed flow of the mode switching process in the smart glasses will be described with reference to the flowchart of FIG. 6. The following processing is implemented by the CPU 201 deploying a program stored in the ROM 203 to the RAM 204 for executing the program. The same applies to each software module.

In step S601, the CPU 201 starts mode switching when the detection unit 303 detects a mode switching instruction. The process waits in step S601 until the switching instruction is detected. Here, the mode switching instruction is, for example, an instruction by a user's operation. The mode is switched by the user touching a predetermined object of the virtual UI or performing a predetermined gesture operation.

Here, the predetermined gesture operation is an operation for holding the hand at a predetermined position for a predetermined duration of time or an operation of waving the hand. The gesture operation for switching the mode may be set in advance by the user.

In step S602, the CPU 201 determines whether the instruction detected in step S601 is an instruction for switching a mode to the silent mode. If it is the instruction to switch a mode to the silent mode (Yes in S602), the process proceeds to S603, and if it is not (No in S602), the process proceeds to S609.

In step S603, the switching unit 309 starts switching a mode to the silent mode according to the instruction from the CPU 201.

In step S604, the CPU 201 determines whether the switching instruction detected in step S601 is an instruction to use the physical UI. If it is determined that the switching instruction is to use the physical UI (Yes in S604), the process proceeds to S605, and if not (No in S604), the process proceeds to S608.

In step S605, the CPU 201 determines whether or not the physical UI is available and in a valid state. If the physical UI is valid (Yes in S605), the process proceeds to S606; otherwise (No in S605), the process proceeds to S607.
Silent mode: If the physical UI is enabled, in step S606, the CPU 201 stops the display of the first virtual UI 404 and starts the display of the second virtual UI 504, and ends the processing.
Silent mode: If the physical UI is not enabled, in step S607, the CPU 201 stops the display of the first virtual UI 404 and starts the display of the second virtual UI 504, enables the physical UI, and ends the process.

If the physical UI is used in the silent mode, the user can operate the smart glasses using both the second virtual UI 504 and the physical UI or using only the physical UI. If the operation is performed using only the physical UI, the second virtual UI 504 displays only an image for the user as a display, not as a user interface (UI).

In step S608 (No in S604), the CPU 201 stops the display of the first virtual UI 404 and starts the display of the second virtual UI 504, and ends the process.

In step S609 (No in S602), the CPU 201 starts switching a mode to the normal mode. In step S610, the CPU 201 stops the display of the second virtual UI 504 and starts the display of the first virtual UI 404, and ends the process.

The mode switching processing of the smart glasses shown in FIG. 6 allows the user to switch the UI used in the normal mode and the silent mode according to situations, and also allows the user to operate the smart glasses without any inconvenience, thereby improving the convenience. Specifically, when using the smart glasses in public transportation such as trains and buses, the operation range can be narrowed down by displaying the virtual UI in a small size or in the vicinity of the user if there are people around. Although the above flow chart shows an example in which a screen is displayed in a small size or in the vicinity of the user, it may be a different way of displaying the screen as long as the operation range from the user in the real space can be narrowed down. For example, only the operation object may be brought close to the user.

In addition, the user is also allowed to select an operation method after switching a mode to the silent mode. That is, after switching a mode to the silent mode, the user still can select whether the operation should be performed: only by the second virtual UI 504; only by the physical UI; or by both the second virtual UI 504 and the physical UI.

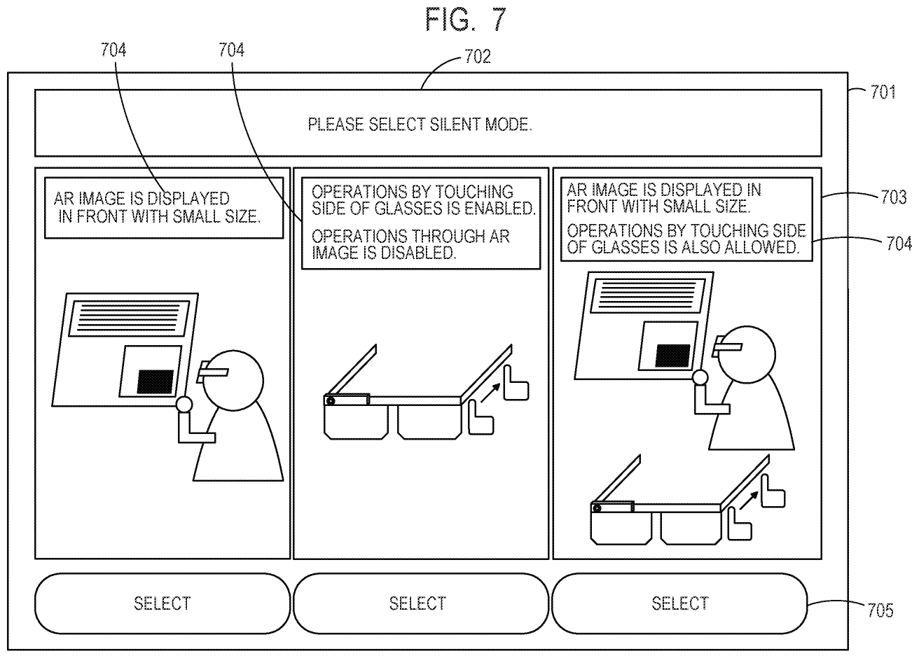

FIG. 7 shows a UI example used for selecting an operation method to be used during the silent mode according to the present embodiment. The selection of the operation method may be displayed every time the silent mode is switched to the silent mode or may be set in advance. The selected operation method is stored as the setting of the device.

A UI screen 701 shows a user interface (UI) displayed as an AR image, and includes a title window 702, a main window 703, an item window 704, and an input window 705. The main window 703 shows a display method and an operation method in the silent mode. The display method and an explanation of the operation method in the silent mode are displayed in each item window 704. In response to selecting and setting the operation method used in the silent mode by the user through the input window 705, the smart glasses 101 operates according to the operation method selected and set by the user during the silent mode. Here, the user is allowed to select whether the operation is performed only by the second virtual UI 504, only by the physical UI, or by using both the second virtual UI 504 and the physical UI.

### Second Embodiment

According to the first embodiment, since the operation method changes when the mode is switched from the normal mode to the silent mode, the user may be confused with the operation. Therefore, it may be necessary that the user is notified of the operation method after the mode is switched so as not to be confused with the operation. The same applies when the mode is switched from the silent mode to the normal mode.

In the second embodiment, in addition to the switching between the normal mode and the silent mode according to the first embodiment, a method of notifying the user of the operation method at the timing when the mode is switched will be described.

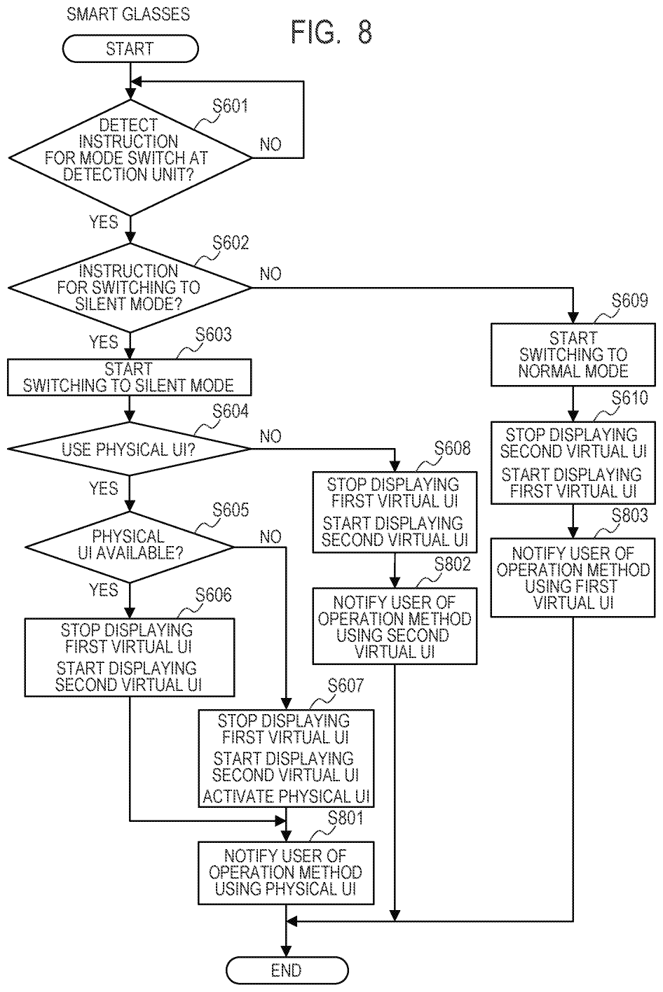

FIG. 8 is a flowchart of the mode switching method shown in FIG. 6 with the operation method notification process added thereto. The same numerical symbols are given to steps similar to those in FIG. 6, and description thereof will be omitted.

In step S603, the switching to the silent mode is started. If the physical UI is used (Yes in step S604), and if the physical UI is enabled (Yes in S605, or No in S605, but physical UI is enabled in S607), the CPU 201 advances the process to step S801.

In step S801, the CPU 201 notifies the operation method using the physical UI, and ends the processing.

If the physical UI is not used (No in S604) and the operation in the silent mode is the operation using the second virtual UI 504 (S608), the CPU 201 notifies the user of the operation method using the second virtual UI 504 in S802, and ends the processing.

If the mode is switched to the normal mode, and the operation method is changed to the method using the first virtual UI 404 (No in S602), the CPU 201 notifies the user of the operation method using the first virtual UI 404 in S803, and ends the processing.

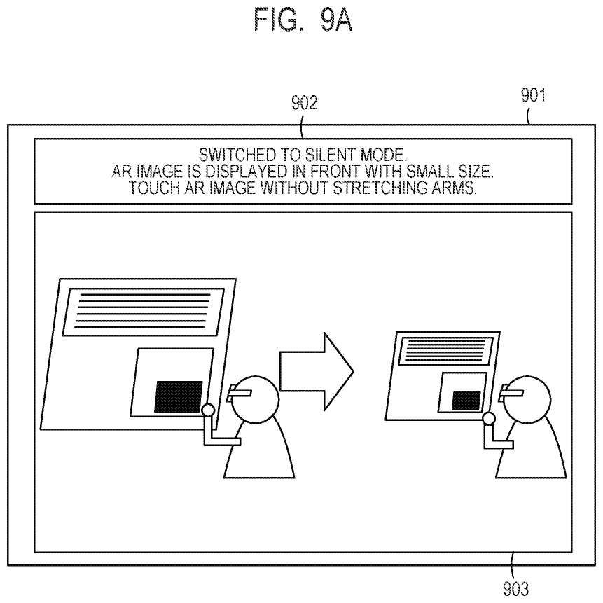

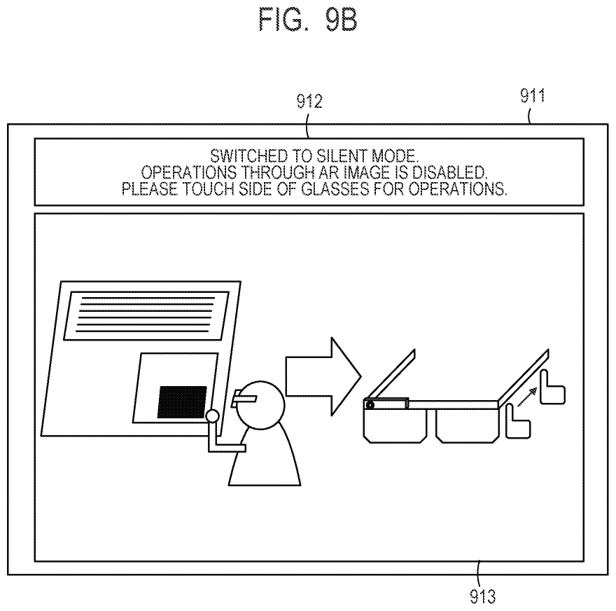

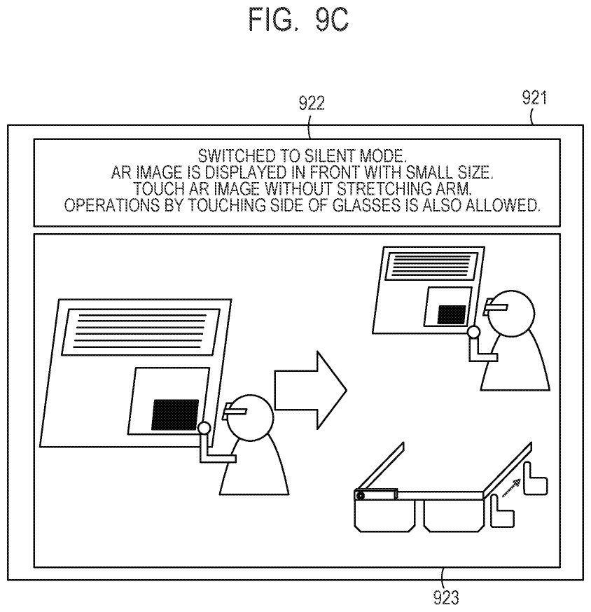

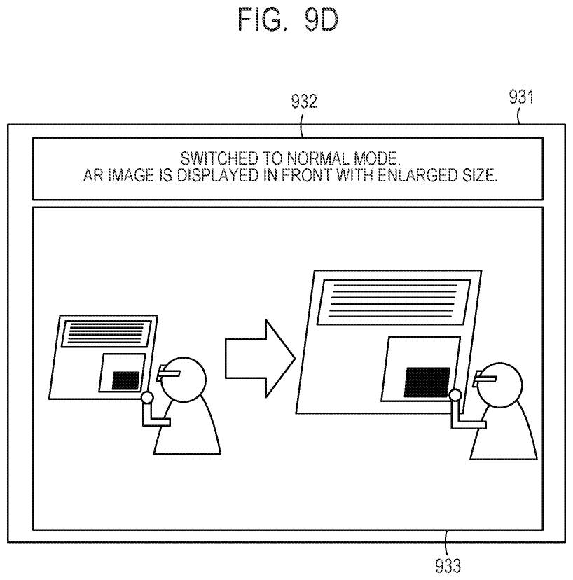

FIG. 9A, FIG. 9B, FIG. 9C, and FIG. 9D show examples of user interface (UI) for notifying the operation method to the user.

FIG. 9A shows an example of UI for an operation guide notifying an operation method when the normal mode is switched to the silent mode with an operation method in which only the second virtual UI 504 is used (i.e., step S802 in FIG. 8). A UI screen 901 shows a UI displayed by an AR image, and includes a title window 902 and a main window 903. The title window 902 shows that the mode is switched from the normal mode to the silent mode, and the main window 903 shows the above switching with a drawing.

FIG. 9B shows an example of UI for an operation guide notifying an operation method when the normal mode is switched to the silent mode with an operation method in which only the physical UI is used (i.e., S801 in FIG. 8). A UI screen 911 shows a UI displayed by an AR image, and includes a title window 912 and a main window 913. The title window 912 shows that the mode is switched from the normal mode to the silent mode, and the main window 913 shows the above switching with a drawing.

FIG. 9C shows an example of UI for an operation guide notifying an operation method when the normal mode is switched to the silent mode with an operation method in which both the second virtual UI 504 and the physical UI are used (i.e., step S801 in FIG. 8). A UI screen 921 shows a UI displayed by an AR image, and includes a title window 922 and a main window 923. The title window 922 shows that the mode is switched from the normal mode to the silent mode, and the main window 923 shows the above switching with a drawing.

FIG. 9D shows an example of UI for an operation guide notifying an operation method when the silent mode with the operation method in which only the second virtual UI 504 is used is switched to the normal mode (i.e., step S803 in FIG. 8). A UI screen 931 shows a UI displayed by an AR image, and includes a title window 932 and a main window 933. The title window 932 shows that the mode is switched from the normal mode to the silent mode, and the main window 933 shows the above switching with a drawing.

It should be noted that the user may be allowed to set whether the operation method at the time of switching between the normal mode and the silent mode is notified or not.

According to the second embodiment, the processing shown in FIG. 8 allows the user to know the operation method at the time of switching the mode, and thus the device usability is improved.

### Third Embodiment

In the first and second embodiments, some examples in which the user switches a mode to the normal mode or to the silent mode by operating the smart glasses 101 have been described. However, it could be troublesome for a user to provide an instruction for switching a mode. Therefore, the third embodiment shows an example in which the smart glasses capture an image around the user in real time, and then the smart glasses recognize a situation around the user, and then the smart glasses automatically switch a mode between the normal mode and the silent mode based on the recognition result.

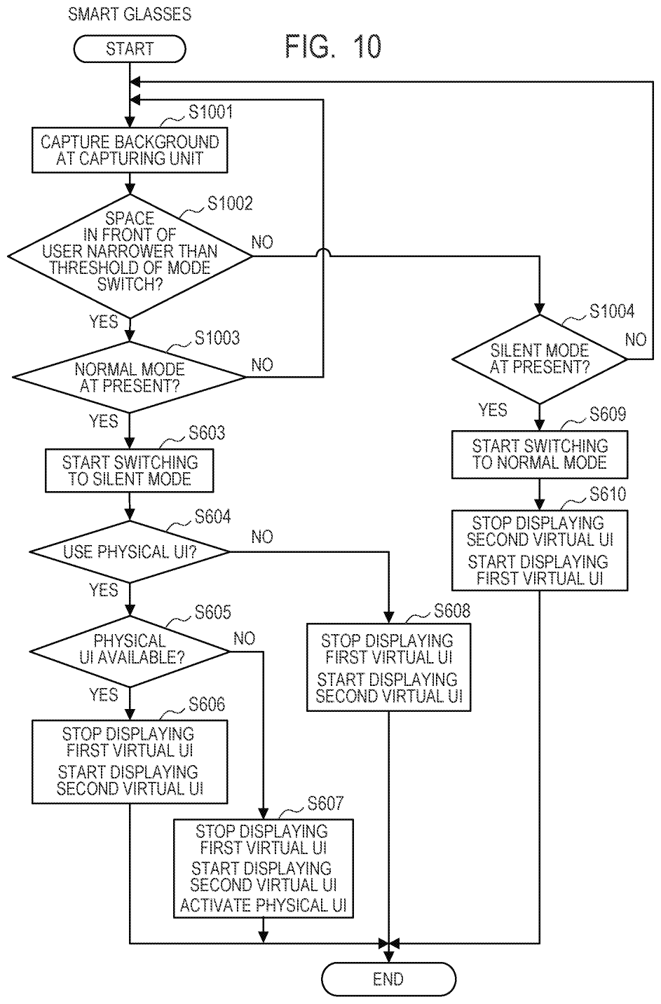

FIG. 10 shows a flowchart of a process in which the smart glasses automatically switch a mode between the normal mode and the silent mode based on a situation in front of the user. It should be noted that the flow shown in FIG. 10 is based on the flow shown in FIG. 6 but further includes a step of recognizing the situation in front of the user, and a step of automatically switching the mode. The steps common to those shown in FIG. 6 are denoted by common numerical symbols, and will not be described below.

In step S1001, the capturing unit 305 captures an image of the outside view and acquires the image.

In step S1002, the CPU 201 recognizes a space in front of the user where no obstacle is present, and determines whether or not the space is within a threshold. The space recognition is executed by using: the captured image acquisition unit 304 configured to acquire an image of the outside view captured by the capturing unit 305; and the detection unit 303 configured to analyze the image and detect the position of the object. The space recognition can be realized by using a known technique (for example, refer to Japanese Patent Application Laid-Open No. 2010-190432).

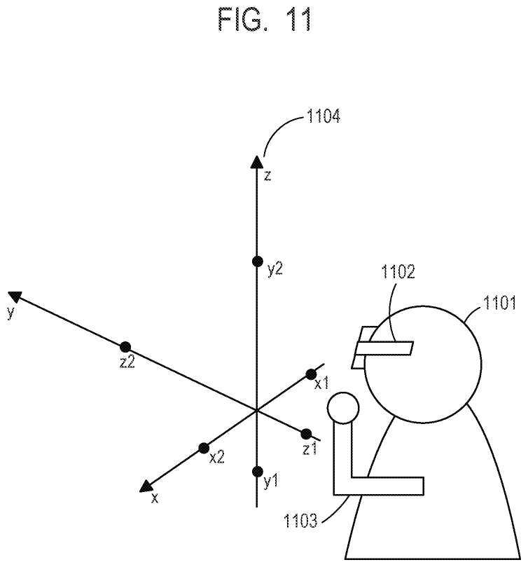

The threshold value will be described using FIG. 11. FIG. 11 is an example of setting a predetermined threshold value in a space in front of the user. FIG. 11 shows a user 1101, smart glasses 1102, an arm 1103 of the user who performs the gesture, and spatial coordinates 1104. The user 1101 is a person who operates the smart glasses and wears the smart glasses 1102 on the head area. A space of a rectangular parallelepiped (x1≤x≤x2, y1≤y≤y2, z1≤x≤z2) defined by the coordinates (x1, x2, y1, y2, z1, z2) plotted on the spatial coordinates 1104 indicates a range within which the user's arm can reach. In the example shown in FIG. 11, the space of the rectangular parallelepiped (x1≤x≤x2, y1≤y≤y2, z1≤z≤z2) is used as a threshold value for mode switching. In step S1002, if the detection unit 303 detects an object in the space designated by the coordinates (x1, x2, y1, y2, z1, z2), the space in front of the user is determined to be within a predetermined threshold value for the switching to the silent mode. The threshold in FIG. 11 is merely an example, and the threshold may not be defined as a rectangular parallelepiped. The threshold may also have a buffer. The threshold value may be set by the user.

In step S1002, if the CPU 201 determines that the space in front of the user is within the predetermined threshold for switching the mode to the silent mode (Yes in step S1002), the process proceeds to step S1003; otherwise (No in step S1002), the process proceeds to step S1004.

In step S1003, the CPU 201 determines whether the current mode is the normal mode or not. If the smart glasses are currently in the normal mode (Yes in S1003), the process proceeds to S603 to start switching the mode to the silent mode. Otherwise (No in S1003), the process returns to S1001.

On the other hand, if it is determined that the space in front of the user is outside the predetermined threshold for switching the mode to the silent mode (No in S1002), the CPU 201 determines whether or not the silent mode is currently selected in S1004. If the silent mode is not currently selected (No in S1004), the process returns to S1001, and if the silent mode is currently selected (Yes in S1004), the process advances to S609 to start switching the mode to the normal mode.

As described above, the processing shown in FIG. 10 eliminates the need for the user to provide an instruction for the mode switching operation, which allows to improve the usability of the smart glasses. In the present example, if there is an obstacle in the range of the gesture operation of the user, the mode is automatically switched to the silent mode. This is not the only trigger to switch the mode to the silent mode. For example, the mode may be switched to the silent mode by the smart glasses if determining that the user is on public transportation such as a train based on an image captured by the capturing unit installed in the smart glasses. The smart glasses may acquire the sound of the surroundings by the microphone installed in the smart glasses, detect the situation in the vicinity of the user, and switch the mode to the silent mode according to the detection result. Further, the smart glasses may be configured to recognize the surrounding situation by using the captured image and the acquired voice. That is, the smart glasses are configured to determine the situation around the user on the basis of the captured image and the acquired voice, and automatically switches the mode on the basis of the determination result.

According to the method of the third embodiment, the normal mode and the silent mode can be automatically switched.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-068875 filed Apr. 15, 2021, which is hereby incorporated by reference herein in its entirety.

What is claimed is:

1. A wearable information processing apparatus comprising:
at least one memory; and
at least one processor in communication with the at least one memory,
wherein the at least one processor of the information processing apparatus is configured to perform:
projecting an operation screen on a field of vision of a user through the information processing apparatus,
wherein the projected operation screen has first and second modes, an operation screen displayed in the second mode having a smaller size than an operation screen displayed in the first mode, or
wherein the operation screen displayed in the second mode is displayed nearer to the field of vision of the user than the operation screen displayed in the first mode.

2. The information processing apparatus according to claim 1, wherein the at least one processor is further configured to perform detecting an operation to the projected operation screen by the user.

3. The information processing apparatus according to claim 1, wherein the operation screen displayed in the second mode has a smaller operation range than the operation screen displayed in the first mode.

4. The information processing apparatus according to claim 1 further comprising a physical operation unit configured to receive an operation to the operation screen.

5. The information processing apparatus according to claim 1, wherein the at least one processor is further configured to perform setting an operation method in the second mode in receipt of receiving an operation by the user.

6. The information processing apparatus according to claim 1, wherein the at least one processor is further configured to perform causing the operation screen to display an operation method when switching the first and second modes.

7. The information processing apparatus according to claim 1, wherein the at least one processor is further configured to perform switching between the first and second modes in response to an instruction from the user.

8. The information processing apparatus according to claim 1, wherein the at least one processor is further configured to perform:
acquiring an image of background; and
switching from the first mode to the second mode based on the acquired image of background.

9. The information processing apparatus according to claim 1, wherein the at least one processor is further configured to perform:
acquiring an image of background;
recognizing a space in front of the user from the acquired image; and
switching from the first mode to the second mode if determined that the recognized space is narrower than a predetermined threshold.

10. The information processing apparatus according to claim 1, wherein the first mode provides a first virtual user interface, and the second mode provides a second virtual user interface.

11. A method for a wearable information processing apparatus comprising:
projecting an operation screen on a field of vision of a user through the information processing apparatus,
wherein the projected operation screen has first and second modes, an operation screen displayed in the second mode having a smaller size than an operation screen displayed in the first mode, or
wherein the operation screen displayed in the second mode is displayed nearer to the field of vision of the user than the operation screen displayed in the first mode.

12. A non-transitory computer-readable storage medium storing a program to cause a computer to perform a method for a wearable information processing apparatus, the method comprising:
projecting an operation screen on a field of vision of a user through the information processing apparatus,
wherein the projected operation screen has first and second modes, an operation screen displayed in the second mode having a smaller size than an operation screen displayed in the first mode, or
wherein the operation screen displayed in the second mode is displayed nearer to the field of vision of the user than the operation screen displayed in the first mode.
